(19) United States
(12) Patent Application Publication
(10) Pub. No.: US 2009/0113659 A1
(43) Pub. Date: May 7, 2009

(54) Discharging apparatus and vacuum cleaner having the same

(75) Inventors: Kyong-hui Jeon, Chungcheongnam-do (KR); Jea-sun You, Gwangju-city (KR)

Correspondence Address: Paul D. Greeley;Ohlandt, Greeley, Ruggiero & Perle, L.L.P., 10th Floor, One Landmark Square, Stamford, CT, 06901-2682, US

(73) Assignee: Samsung Gwangju Electronics Co., Ltd.

(21) Appl. No.: 12/150,640

(22) Filed: Apr. 30, 2008

(30) Foreign Application Priority Data
Nov. 5, 2007 (KR) 2007-111978

(51) Int. Cl. A47L 9/10; B01D 50/00; A47L 5/36

(52) U.S. Cl. 15/327.1; 55/385.1; 15/347

(57) ABSTRACT

A discharge apparatus of a vacuum cleaner, which does not allow a sealing to break due to a discharge force, and a vacuum cleaner having the same, are provided. The discharge apparatus includes a motor to generate a discharge force, a discharge filter unit to filter discharged air, a housing to support the motor, and comprising a filter accommodating unit integrally foxed thereon to receive the discharge filter unit therein, and a sealing member to seal a space defined between the discharge filter unit and the filter accommodating unit.

### CROSS-REFERENCE TO RELATED APPLICATIONS

This application claims the benefit under 35 U.S.C. §119(a) of Korean Patent Application No. 10-2007-0111978, filed on Nov. 5, 2007, in the Korean Intellectual Property Office, the entire contents of both of which are hereby incorporated by reference.

### BACKGROUND OF THE INVENTION

1. Field of the Invention

The present disclosure relates to a discharge apparatus to discharge air, and a vacuum cleaner having the same.

2. Description of the Related Art

A conventional vacuum cleaner draws in dust and air generally from a floor using a suction force generated therein, while traveling along the floor. The vacuum cleaner includes a brush assembly to move along the floor, a dust separating apparatus to separate dust debris or other matter from the drawn air, and a discharge apparatus to discharge the clean air.

The discharge apparatus includes a motor unit to generate a discharge force, and a discharge filter unit to filter the previously filtered air before the air is discharged outside of the vacuum cleaner by the discharge force.

The discharge filter unit is disposed in back of the motor unit, that is, disposed in a direction where the air is discharged by the discharge force generated from the motor unit. A sealing member such as a general O-ring is disposed along the connecting part between the motor unit and the discharge filter unit.

However, the discharge filter unit is blown backward by the discharge force exerting in the discharging direction when the air passes the discharge filter unit. Accordingly, the sealing is broken between the motor unit and the discharge filter unit and minute dust debris or other matter leaks through the openings made by the breakage.

### SUMMARY OF THE INVENTION

An aspect of the present disclosure is to address at least the above problems and/or disadvantages and to provide at least the advantages described below. Accordingly, an aspect of the present disclosure is to provide a discharge apparatus for preventing breakage of sealing due to a discharge force, and a vacuum cleaner having the same.

In accordance with an aspect of the present disclosure, a discharge apparatus of a vacuum cleaner includes a motor to generate a discharge force, a discharge filter unit to filter discharged air, a housing to support the motor, and comprising a filter accommodating unit integrally formed thereon to receive the discharge filter unit therein, and a sealing member to seal a space defined between the discharge filter unit and the filter accommodating unit.

The sealing member may include an O-ring disposed between a support formed on the discharge filter unit, and a locking recess formed in the filter accommodating unit to correspond to the support.

The support and the locking recess may be inclined toward a discharge direction by a predetermined angle.

The discharge apparatus may further include a packing unit to pack a space formed between a discharge filter insert hole formed on the filter accommodating unit, and the discharge filter unit.

The packing unit may include a first and second sealing wings to enable a two-point contact with an outer circumference of the discharge filter unit.

In accordance with an aspect of the present disclosure, a discharge apparatus of a vacuum cleaner includes a motor to generate a discharge force, a discharge filter unit to filter discharged air, a housing to support the motor, and comprising a filter accommodating unit integrally formed therein to receive the discharge filter unit therein, and a sealing unit to seal a space defined between the discharge filter unit and the filter accommodating unit. The sealing unit may include a sealing member disposed between the discharge filter unit and a rear- wall of the filter accommodating unit at a downstream in the discharge direction, to be squeezed by a discharge force exerted to the discharge filter unit, and a packing member disposed on a discharge filter unit insert hole formed on the filter accommodating unit, and comprising a first and second sealing wings to enable a two-point contact with an outer circumference of the discharge filter unit when the discharge filter unit is received. In accordance with an aspect of the present disclosure, a vacuum cleaner includes a brush assembly to travel along a surface being cleaned, a vacuum cleaner body to receive a dust separating apparatus therein to separate dust debris or other matter from air drawn in through the brush assembly, and a discharge apparatus to filter minute dust debris or other matter from the air which passes the dust separating apparatus, and discharge the filtered air. The discharge apparatus may include a motor to generate a discharge force, a discharge filter unit to filter discharged air, a housing to support the motor, and comprising a filter accommodating unit integrally formed thereon to receive the discharge filter unit therein, and a sealing member to seal a space defined between the discharge filter unit and the filter accommodating Unit.

### BRIEF DESCRIPTION OF THE DRAWING FIGS.

The above and other objects, features, and advantages of certain exemplary embodiments of the present disclosure will be more apparent from the following description taken in conjunction with the accompanying drawings, in which:

FIG. 1 is a perspective view of a vacuum cleaner according to an exemplary embodiment of the present invention;

FIG. 2 is a perspective view of a discharge apparatus as a main part of an exemplary embodiment of the present invention;

FIG. 3 is an exploded perspective view of FIG. 2;

FIG. 4 is a cross-section view of FIG. 2; and

FIGS. 5A and 5B are cross-section views illustrating the operation of a packet unit.

Throughout the drawings the same reference numerals will be understood to refer to the same elements, features, and structures.

### DETAILED DESCRIPTION OF THE EXEMPLARY EMBODIMENTS

Hereinafter, a vacuum cleaner for use in both an upright form and a canister form according to exemplary embodiments of the present disclosure will be described in detail with reference to the accompanying drawing figures wherein only a canister form vacuum cleaner is shown for the sake of brevity.

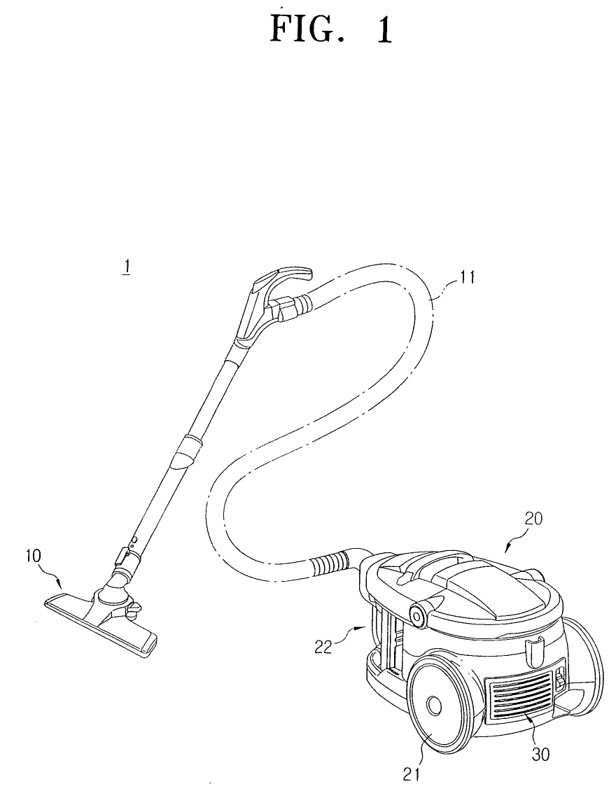

Referring to FIG. 1, a vacuum cleaner 1 according to an exemplary embodiment of the present invention includes a brush assembly 10, a vacuum cleaner body 20, and a discharge apparatus 30.

The user of the vacuum cleaner moves the brush assembly 10 along generally a floor, while keeping the brush assembly 10 to face the floor. Although not illustrated, the brush assembly 10 may include a brush member to remove dust debris or other matter from the floor by hitting or scratching, and a suction port to draw in dust-laden air from the floor.

The vacuum cleaner body 20 moves along the floor using moving means such as wheels 21. Although not illustrated, the vacuum cleaner body 20 may include a dust separating apparatus 22 therein, such as, but not limited to, a cyclone device to separate dust debris or other matter from the drawn air using cyclone current.

The dust-laden air is drawn through the brush assembly 10, and enters the vacuum cleaner body 20 through appropriate connecting means such as a hose 1.

Since the technical constitution of the brush assembly 10 and the vacuum cleaner body 20 are generally known, this will not be explained below for the sake of brevity.

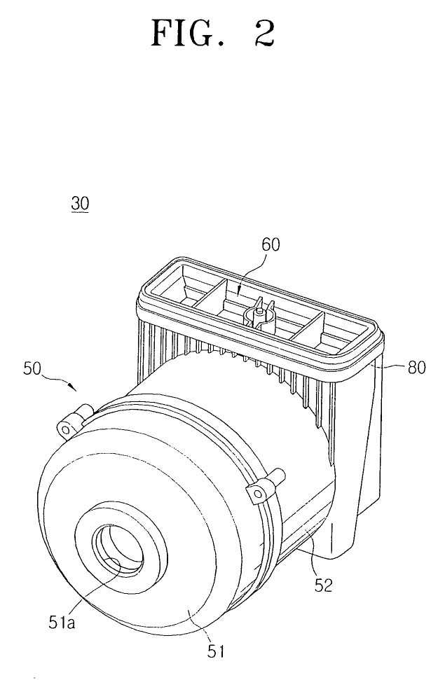

The discharging apparatus 30 is mounted in the vacuum cleaner body 20 to discharge drawn air outside. Referring to FIGS. 2 to 4, the discharging apparatus 30 includes a motor 40, a housing 50, a discharge filter unit 60, a sealing member 70, and a packing unit 80.

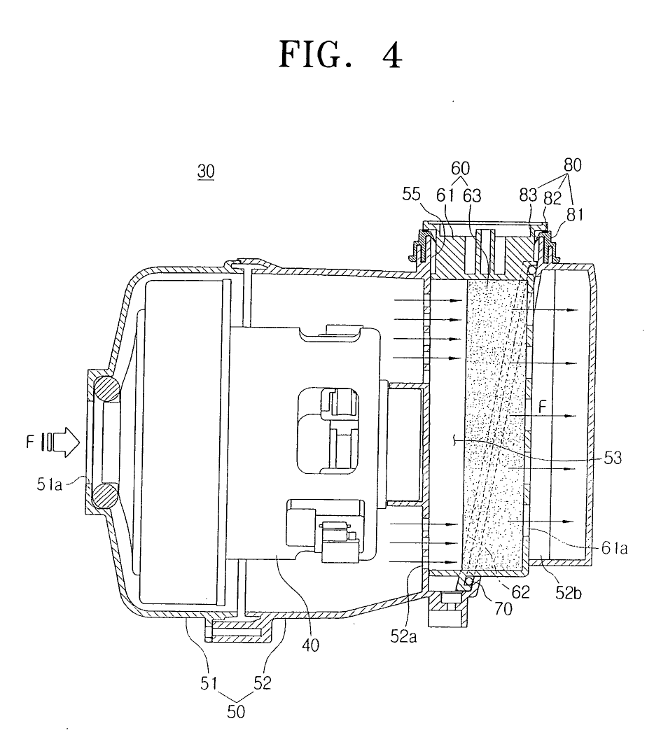

The motor 40 drives to generate an air current for cleaning. Specifically, the motor 40 generates both a suction force to drawn in dust-laden air into the vacuum cleaner body 20 through the brush assembly 10, and a discharge force F (FIG. 4) to discharge the filtered air outside the vacuum cleaner body 20.

Since the technical constitution of the motor 40 to generate such an air current is generally known, this will not be explained below for the sake of brevity.

The housing 50 includes a front and rear housings 51 and 52 to support the front and back of the motor 40 in the discharging direction. In other words, the motor 40 is accommodated in a space defined between the front and rear housings 51 and 52.

The front housing 51 includes a suction hole 5la extended therethrough to guide the drawn air toward the motor 40, while the discharge housing 52 includes a plurality of discharge holes 52 to pass the air after the air is passed through the motor 40. The rear housing 52 also includes a discharge opening 52a extended therethrough to guide the air outside the vacuum cleaner body 20 after the air is filtered through the discharge holes 52a. The discharge opening 52b faces the discharge holes 52a at a predetermined distance from each other.

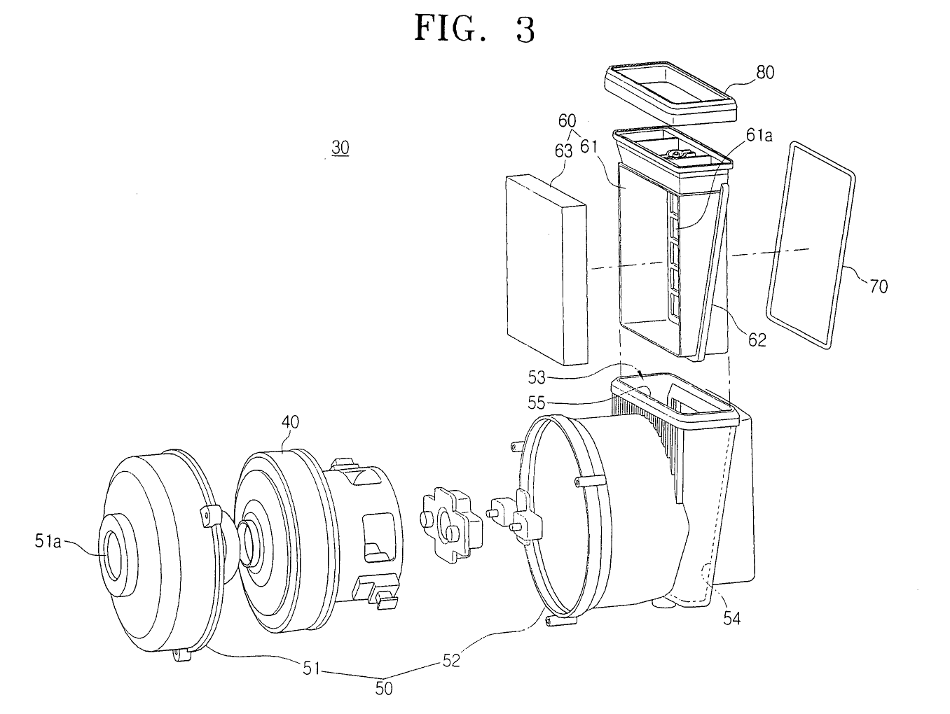

The discharge filter unit 60 is connected to a portion of the motor 40 to filter minute dust debris or other matter from the discharged air. Referring to FIG. 3, the discharge filter unit 60 may include a discharge filter body 61 and a discharge filter member 62.

The discharge filter body 61 is supported by the rear housing 52, and includes a filter hole 61a formed in the back portion in the discharging direction. The discharge filter body 61 is received in a filter accommodating unit 53 of the rear housing 52.

The filter accommodating unit 53 is disposed in a space defined between the discharge holes 52a and the discharge opening 52b of the rear- housing 43. In other words, the filter accommodating unit 53 is formed integrally with the rear- housing 52. The discharge filter body 61 is passed through a insert hole 55 formed in the upper portion of the filter accommodating unit 53 to be received in the filter accommodating unit 53.

A support 62 is formed along the outer surface of the discharge filter body 61 to restrain a range of movement of the discharge filter body 61 by the discharge force F while the discharge filter body 61 is received in the filter accommodating unit 53. A locking recess 54 is formed along the inner side of the filter accommodating unit 53 to correspond to the support 62 of the discharge filter body 61.

Accordingly, even when the discharge filter body 61 is subjected to the discharge force F, the discharge filter body 61 is stably supported by the interference between the support 62 of the discharge filter body 61 with the locking recess 54 of the filter accommodating unit 53 of the rear housing 52. Herein, the rear housing 52 is fixed to the vacuum cleaner body 20.

Referring to FIGS. 3 and 4, the discharge filter member 62 is supported on the discharge filter body 61 to filter minute unfiltered dust debris or other matter of the air blowing from the dust separating apparatus 22 (not illustrated). Accordingly, clean, filtered air from the discharge filter member 62 is passed through the filter holes 61a of the discharge filter body 61 and the discharge opening 52b of the rear casing 52 in sequence, and finally discharged outside the vacuum cleaner body 20.

The discharge filter member 62 may include at least one of general minute dust filtering means such as a high efficiency particulate air filter or help a filter to provide high filtering efficiency.

The sealing member 70 is disposed between the filter accommodating unit 53 of the rear housing 52 and the discharge filter body 61 to seal a connection area between the discharge filter unit 60 and the housing 50.

The sealing member 70 may be implemented as an O-ring, which is disposed between he support 62 formed along the outer surface of the discharge filter body 61 and the locking recess 54 formed along the inner surface of the rear housing 52. The support 62 and the locking recess 54, and also the sealing member 70 disposed therebetween may be inclined at a predetermined angle with respect to the discharge direction F.

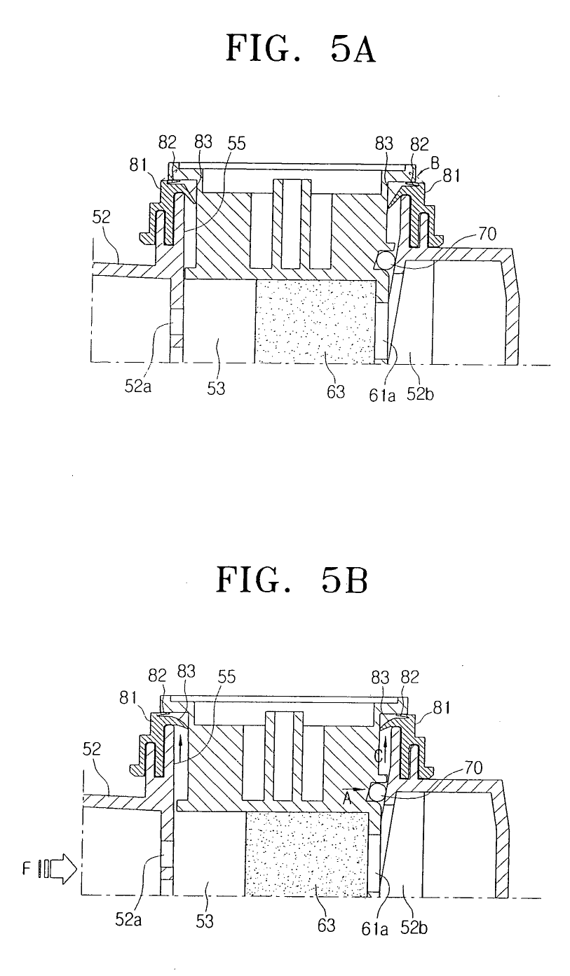

According to the above structure, the sealing member 70 is pushed by the discharge filter body 61 in A direction of FIG. 5B, as the discharge filter 61 is subjected to the discharge force F exerted in discharging direction. Accordingly, the sealing member 70 is squeezed against the locking recess 54 of the rear housing 52. The rear housing 52, being fixed to the vacuum cleaner body 20 where the motor 40 is mounted, does not move even when the discharge filter body 61 is pushed in the discharging direction. Therefore, as the discharge filter unit 60 keeps squeezing against the inner surface of the rear housing 52 with the intervention of the sealing member 70 disposed therebetween, sealing force increases.

The packing unit 80 packs both the insert hole 55 on the upper portion of the filter accommodating unit 53 and the discharge filter unit 60. Referring to FIGS. 5A and 5B, the packing unit 80 includes a packing body 81, and a first and second sealing wings 82 and 83.

The packing body 81 is formed between the insert hole 55 of the rear housing 52 and the discharge filter body 61. Specifically, referring to FIG. 3, the packing body 81 is disposed along the rim of the insert hole 55 and packed into the space defined between the discharge filter body 61 and the rim of the insert hole 55 according to the force of inserting the discharge filter body 61 in the filter accommodating unit 53 through the insert hole 55.

The first and second sealing wings 82 and 83 are deformed by the external force, in which the first and second sealing wings 82 and 83 may be extended from the packing body 81 by unfolding or further folding, and brought to a contact with the outer surface of the discharge filter unit 60 in at least two locations.

Specifically, the first sealing wing 82 is folded in B direction (FIG. 5A) due to the discharge filter body 61 inserted in the insert hole 55. As shown in phantom line of FIG. 5A, the first sealing wing 82 is in unfolded stage when the packing body 61 packs the rim of the insert hole 55. The first sealing wing 82 is then folded in B direction (solid line) by being interfered with the inserting force of the discharge filter body 61. As a result, the first sealing wing 82 contacts the outer surface of the discharge filter body 61 to seal a space between the insert hole 55 and the discharge filter body 61.

Referring to FIG. 5A, the second sealing wing 65 is sealing a space defined between the insert hole 55 and the discharge filter body 61. Referring to FIG. 5B, the second sealing wing 65 is squeezed in C direction by the discharge force F to an approximately parallel relation with respect to the discharging direction. As a result, the second sealing wing 65 secondly seals the space between the insert hole 55 and the discharge filter body 61.

The second sealing wing 65 may desirably have a length that exceeds that of the space formed between the insert hole 55 of the rear housing 52 and the discharge filter body 61, so as to provide a sealing force upon being unfolded by the discharge force F.

While the sealing member 70 seals the space between the filter accommodating unit 53 and the side surface of the discharge filter unit 60, and the packing unit 80 seals the space formed between the insert hole 55 and the upper portion of the discharge filter unit 60, the locations of sealing may vary. For example, the sealing member 70 or the packing unit 80 may be disposed anywhere that has a gap defined between the discharge filter unit 60 and the filter accommodating unit 53.

The operations of discharging and sealing of the discharging apparatus of the vacuum cleaner constructed as explained above will be explained below with reference to FIGS. 1, and 4 to 5B.

Referring to FIG. 1, the brush assembly 10 draws in dust-laden air from a floor using a suction force generated from the motor 40 of the vacuum cleaner body 20. The in-drawn air flows to the interior of the vacuum cleaner body 20 where dust debris or other matter is separated from the air and collected.

Referring to FIG. 4, the filtered air is blown to the discharge apparatus 30 by the discharge force F, passed the discharge filter unit 60, and discharged outside the vacuum cleaner body 20. Accordingly, the in-drawn air is filtered in the dust separating apparatus (not illustrated), and unfiltered minute dust debris or other matter is filtered, once again, through the discharge filter unit 60 before the air is discharged.

If the motor 40 is driven and generates the discharge force F, the discharge filter body 61 is blown in the discharge direction of the discharge force F, and therefore, the sealing member 70 is squeezed between the support 62 and the locking recess 54 of the filter accommodating unit 53 in A direction (FIG. 5B).

The second sealing wing 65 of the packing unit 80, packing tie upper position of the insert hole 55 and discharge filter body 61, is unfolded in C direction (FIG. 5B) by the discharge force F. At this time, the first sealing wing 82 is in folded state in B direction (FIG. 5A) due to the force of the discharge filter unit 60 being inserted in the insert hole 55 receiving the packing body 81.

Since the sealing member 70 gains additional sealing force clue to the discharge force F, the sealing member 70 can tightly seal a space defined between the filter accommodating unit 53 integrally formed with the housing, and the side surface of the discharge filter unit 60. The space defined between the upper open portion of the filter accommodating unit 53 adjacent to the insert hole 55, and the upper portion of the discharge filter unit 60, is thus sealed twice, by the first sealing wing 82 folded due to the insertion of the discharge filter unit 60 and the second sealing wing 83 unfolded clue to the discharge force F.

With the discharge apparatus and a vacuum cleaner having the same according to the exemplary embodiments of the present invention, a filter accommodatling unit, accommodating therein a discharge filter unit, is integrally formed with a housing to support a motor, and a sealing member is interposed between the discharge filter unit received within the filter accommodating unit, and a rear side of the filter accommodating unit. Accordingly, sealing is secured and not broken even when the discharge force is exerted thereto. Furthermore, since the discharge filter unit is squeezed against the housing more tightly, with the sealing member interposed between the discharge filter unit and the housing, additional sealing force is gained.

Although representative exemplary embodiment of the present disclosure has been shown and described in order to exemplify the principle of the present disclosure, the present disclosure is not limited to the specific embodiment. It will be understood that various modifications and changes can be made by one skilled in the art without departing from the spirit and scope of the disclosure as defined by the appended claims. Therefore, it shall be considered that such modifications, changes and equivalents thereof are all included within the scope of the present disclosure.

What is claimed is:

1. A discharge apparatus of a vacuum cleaner, comprising:
a motor to generate a discharge force;
a discharge filter unit to filter discharged air;
a housing to support the motor, and comprising a filter accommodating unit integrally formed thereon to receive the discharge filter unit therein; and
a sealing member to seal a space defined between the discharge filter unit and the filter accommodating unit.

2. The discharge apparatus of claim 1, wherein the sealing member comprises an O-ring disposed between a support formed on the discharge filter unit, and a locking recess formed in the filter accommodating unit to correspond to the support.

3. The discharge apparatus of claim 2, wherein the support and the locking recess are inclined toward a discharge direction by a predetermined angle.

4. The discharge apparatus of claim 2, further comprising a packing unit to pack a space formed between a discharge filter insert hole formed on the filter accommodating unit and the discharge filter unit.

5. The discharge apparatus of claim 4, wherein the packing unit comprises a first sealing wing and a second sealing wing to enable a two-point contact with an outer circumference of the discharge filter unit.

6. A discharge apparatus of a vacuum cleaner, comprising:
a motor to generate a discharge force;
a discharge filter unit to filter discharged air;
a housing to support the motor, and comprising a filter accommodating unit integrally formed thereon to receive the discharge filter unit therein; and
a sealing unit to seal a space defined between the discharge filter unit and the filter accommodating unit, the sealing unit comprising:
a sealing member disposed between the discharge filter unit and a rear wall of the filter accommodating unit, the sealing member being downstream of the discharge filter unit in a discharge directions to be squeezed by a discharge force excited to the discharge filter unit, and
a packing member disposed on a discharge filter unit insert hole formed on the filter accommodating unit, the packing member comprising a first sealing wing and a second sealing wing to enable a two-point contact with an outer circumference of the discharge filter unit when the discharge filter unit is received.

7. A vacuum cleaner comprising:
a brush assembly to travel along a surface being cleaned;
a vacuum cleaner body to receive a dust separating apparatus therein to separate dust debris or other matter from air drawn in through the brush assembly; and
a discharge apparatus to filter minute dust debris or other matter from the air which passes the dust separating apparatus, and discharge the filtered air, the discharge apparatus comprising,
a motor to generate a discharge force,
a discharge filter unit to filter discharged air,
a housing to support the motor, and comprising a filter accommodating unit integrally formed thereon to receive the discharge filter unit therein, and
a sealing member to seal a space defined between the discharge filter unit and the filter accommodating unit.

8. The vacuum cleaner of claim 7, wherein the sealing member comprises an O-ring disposed between a support formed on the discharge filter unit, and a locking recess formed in the filter accommodating unit to correspond to the support.

9. The vacuum cleaner of claim 8, wherein the support and the locking recess are inclined toward a discharge direction by a predetermined angle.

10. The vacuum cleaner of claim 8, further comprising a packing unit to pack a space formed between a discharge filter insert hole formed on the filter accommodating unit, and the discharge filter unit.

11. The vacuum cleaner of claim 10, wherein the packing unit comprises a first and second sealing wings to enable a two-point contact with an outer circumference of the discharge filter unit.

12. A vacuum cleaner comprising:
a brush assembly to travel along a surface being cleaned;
a vacuum cleaner body to receive a dust separating apparatus therein to separate dust debris or other matter from air drawn in through the brush assembly; and
a discharge apparatus to filter minute dust debris or other matter from the air which passes the dust separating apparatus, and discharge the filtered air, the discharge apparatus comprising,
a motor to generate a discharge force.
a discharge filter unit to filter discharged air,
a housing to Support the motor, the housing having a filter accommodating unit integrally formed thereon to receive the discharge filter unit therein, and
a sealing unit to seal a space defined between the discharge filter unit and the filter accommodating unit, the sealing unit comprising,
a sealing member disposed between the discharge filter unit and a rear wall of the filter accommodating unit at a downstream in the discharge direction, to be squeezed by a discharge force exerted to the discharge filter unit, and
a packing member disposed on a discharge filter unit insert hole formed on the filter accommodating unit, and comprising a first sealing wing and a second sealing wing to enable a two-point contact with an outer circumference of the discharge filter unit when the discharge filter unit is received.
